(19) United States
(12) Patent Application Publication
(10) Pub. No.: US 2007/0048345 A1
(43) Pub. Date: Mar. 1, 2007

(54) Antimicrobial composition

(75) Inventors: Lei Huang, Duluth, GA (US); Shu-Ping Yang, Alpharetta, GA (US); Ali Yahiaoui, Roswell, GA (US); Anthony S. Spencer, Woodstock, GA (US)

Correspondence Address: DORITY & MANNING, P.A., POST OFFICE BOX 1449, GREENVILLE, SC, 29602-1449, US

(73) Assignee: Kimberly-Clark Worldwide, Inc.

(21) Appl. No.: 11/364,799

(22) Filed: Feb. 28, 2006

Related U.S. Application Data
(63) Continuation-in-part of application No. 11/217,013, filed on Aug. 31, 2005.

(51) Int. Cl. A01N 43/40; A01N 25/00; A01N 37/30

(52) U.S. Cl. 424/405; 514/738; 424/78.27; 514/358; 514/554

(57) ABSTRACT

An antimicrobial composition that contains an antimicrobial agent and a sugar alcohol is provided. The sugar alcohol is more generally more biocompatible and biodegradable than the antimicrobial agent. In addition, without intending to be limited by theory, it is believed that sugar alcohols increase the attraction of the antimicrobial agent to microorganisms (e.g., the cytoplasmic membrane of bacteria). Because a greater percentage of the antimicrobial agent molecules are brought into contact with the microorganisms, the efficiency of growth inhibition is increased. Thus, the antimicrobial composition provides good efficacy without the need for high levels of an antimicrobial agent.

### RELATED APPLICATIONS

The present application is a continuation-in-part of U.S. application Ser. No. 11/217,013, filed on Aug. 31, 2005.

### BACKGROUND OF THE INVENTION

Antimicrobial agents are used in various applications to inhibit the growth of microorganisms. For example, antimicrobial agents may be used for hospital-acquired infections caused by bacteria, viruses, fungi, or parasites. These microorganisms may already be present in the patient's body or may stem from the environment, contaminated hospital equipment, healthcare workers, or other patients. Depending on the causal agents involved, an infection may start in any part of the body. In recent years, the prevalence of hospital-acquired infections has had serious implications for both patients and healthcare workers. Hospital-acquired infections are those that originate or occur in a hospital or long-term care, hospital-like settings. Hospital-acquired infections also may develop from surgical procedures, catheters placed in the urinary tract or blood vessels, or from material from the nose or mouth that is inhaled into the lungs. The most common types of hospital-acquired infections are urinary tract infections (UTIs), pneumonia due to use of endotracheal ventilators, blood-born pathogen contaminations, and surgical wound infections. Consequently, hospitals and other healthcare facilities extensively use antimicrobial agents for a variety of topical applications. Typically, the antimicrobial agents must be present at a relatively high concentration to achieve the desired level of efficacy. Unfortunately, however, high levels of antimicrobial agents are undesired in many cases. For instance, the use of high levels of certain types of antimicrobial agents (e.g., chlorinated phenols) may be undesired due to the increased likelihood of contacting sensitive areas, such as wounds. Even when high levels of antimicrobial agents are not of paramount concern, it may nevertheless be desired to minimize their use due to cost or environmental concerns.

As such, a need currently exists for an antimicrobial composition that is capable of achieving good efficacy at a relatively low level of antimicrobial agent.

### SUMMARY OF THE INVENTION

In accordance with one embodiment of the present invention, an antimicrobial composition is disclosed that comprises one or more antimicrobial agents in an amount of from about 0.001 wt. % to about 0.5 wt. % and one or more sugar alcohols in an amount from about 0.1 wt. % to about 20 wt. %. The sugar alcohols are selected from the group consisting of pentose alcohols and hexose alcohols.

In accordance with another embodiment of the present invention, a method for inhibiting the growth of a microorganism on a surface is disclosed. The method comprises topically applying an antimicrobial composition to the surface. The composition comprises one or more biocides in an amount of from about 0.001 wt. % to about 0.5 wt. % and one or more sugar alcohols in an amount from about 0.1 wt. % to about 20 wt. %. The antimicrobial composition achieves a log reduction of the microorganism of at least about 3 after exposure thereto for 15 minutes.

Other features and aspects of the present invention are discussed in greater detail below.

### DETAILED DESCRIPTION OF REPRESENTATIVE EMBODIMENTS

Reference now will be made in detail to various embodiments of the invention, one or more examples of which are set forth below. Each example is provided by way of explanation of the invention, not limitation of the invention. In fact, it will be apparent to those skilled in the art that various modifications and variations may be made in the present invention without departing from the scope or spirit of the invention. For instance, features illustrated or described as part of one embodiment may be used on another embodiment to yield a still further embodiment. Thus, it is intended that the present invention covers such modifications and variations as come within the scope of the appended claims and their equivalents.

Generally speaking, the present invention is directed to an antimicrobial composition that contains an antimicrobial agent and a sugar alcohol. The sugar alcohol is generally more biocompatible and biodegradable than the antimicrobial agent. In addition, without intending to be limited by theory, it is believed that sugar alcohols increase the attraction of the antimicrobial agent to microorganisms (e.g., the cytoplasmic membrane of bacteria). Because a greater percentage of the antimicrobial agent molecules are brought into contact with the microorganisms, the efficiency of growth inhibition is increased. Thus, the antimicrobial composition provides good efficacy without the need for high levels of an antimicrobial agent.

Any of a variety of antimicrobial agents may generally be used to inhibit the growth of microorganisms in accordance with the present invention. Suitable types of antimicrobial agents include antibiotics and biocides. Antibiotics are often used in the treatment of infections diseases and typically have a single target and specific mode of action. Biocides, on the other hand, are often effective against a broad spectrum of microorganisms. Although not required, biocides are used in most embodiments of the present invention. Suitable biocides may include, for instance, phenolic antimicrobial agents, such as p-chlorometaxylenol (“PCMX”), 2,4,4′-trichloro-2 hydroxy di-phenyl ether (“triclosan”), 2-chlorophenol, 3-chlorophenol, 4-chlorophenol, 2,4-dichlorophenol, 2,4,6-trichlorophenol, 2,3,4,6-tetrachlorophenol, pentachlorophenol, 4-chlororesorcinol, 4,6-dichlororesorcinol, 2,4,6-trichlororesorcinol, alkylchlorophenols (including p-alkyl-o-chlorophenols, o-alkyl-p-chlorophenols, dialkyl-4-chlorophenol, and tri-alkyl-4-chlorophenol), dichloro-m-xylenol, chlorocresol, o-benzyl-p-chlorophenol, 3,4,6-trichlorphenol, 4-chloro-2-phenylphenol, 6-chloro-2-phenylphenol, o-benzyl-p-chlorophenol, and 2,4-dichloro-3,5-diethylphenol.

Biguanide compounds may also be used as biocides in accordance with the present invention. Examples of such biguanide compounds include, but are not limited to, chlorhexidine free base, chlorhexidine diphosphanilate, chlorhexidine digluconate, chlorhexidine diacetate, chlorhexidine dihydrochloride, chlorhexidine dichloride, chlorhexidine dihydroiodide, chlorhexidine diperchlorate, chlorhexidine dinitrate, chlorhexidine sulfate, chlorhexidine sulfite, chlorhexidine thiosulfate, chlorhexidine di-acid phosphate, chlorhexidine difluorophosphate, chlorhexidine diformate, chlorhexidine dipropionate, chlorhexidine diiodobutyrate, chlorhexidine di-n-valerate, chlorhexidine dicaproate, chlorhexidine malonate, chlorhexidine succinate, chlorhexidine malate, chlorhexidine tartrate, chlorhexidine gluconate (“CHG”), techlorhexidine dimonoglycolate, chlorhexidine monodiglycolate, chlorhexidine dilactate, chlorhexidine di-α-hydroxyisobutyrate, chlorhexidine diglucoheptonate, chlorhexidine diisothionate, chlorhexidine dibenzoate, chlorhexidine dicinnamate, chlorhexidine dimandelate, chlorhexidine di-isophthalate, chlorhexidine di-2-hydroxynapthoate, chlorhexidine embonate, polyhexamethylene biguanide (“PHMB”), and alexidine (N,N″-bis(2-ethylhexyl)-3,12-diimino-2,4,11,13-tetraazatetradecanediimidamine; 1,1′-hexamethyl-enebis [5-(2-ethylhexyl)biguanide]).

Still another suitable class of biocides includes quaternary ammonium antimicrobial agents. Examples of suitable quaternary ammonium antimicrobial agents include, but are not limited to, behenalkonium chloride, cetalkonium chloride, cetarylalkonium bromide, cetrimonium tosylate, cetyl pyridinium chloride, lauralkonium bromide, lauralkonium chloride, lapyrium chloride, lauryl pyridinium chloride, myristalkonium chloride, olealkonium chloride, and isostearyl ethyldimonium chloride. The quaternary ammonium compound may also contain an organosilicone moiety. Some examples of such organosilicone quaternary ammonium compounds include, but are not limited to, organosilicone derivatives of the following ammonium salts: di-isobutylcresoxyethoxyethyl dimethyl benzyl ammonium chloride, di-isobutylphenoxyethoxyethyl dimethyl benzyl ammonium chloride, myristyl dimethylbenzyl ammonium chloride, myristyl picolinium chloride, N-ethyl morpholinium chloride, laurylisoquinolinium bromide, alkyl imidazolinium chloride, benzalkonium chloride, cetyl pyridinium chloride, coconut dimethyl benzyl ammonium chloride, stearyl dimethyl benzyl ammonium chloride, alkyl dimethyl benzyl ammonium chloride, alkyl diethyl benzyl ammonium chloride, alkyl dimethyl benzyl ammonium bromide, di-isobutyl phenoxyethoxyethyl trimethyl ammonium chloride, di-isobutylphenoxyethoxyethyl dimethyl alkyl ammonium chloride, methyl-dodecylbenzyl trimethyl ammonium chloride, cetyl trimethyl ammonium bromide, octadecyl dimethyl ethyl ammonium bromide, cetyl dimethyl ethyl ammonium bromide, octadec-9-enyl dimethyl ethyl ammonium bromide, dioctyl dimethyl ammonium chloride, dodecyl trimethyl ammonium chloride, octadecyl trimethyl ammonium chloride, octadecyl trimethyl ammonium bromide, hexadecyl trimethyl ammonium iodide, octyl trimethyl ammonium fluoride, and mixtures thereof. A commercially available example of such organosilicone-based quaternary ammonium compound is AEM 5772, which may be obtained from Aegis Environments Co., Midland, Mich. In particular, AEM 5772 contains 3-(trimethoxysilyl)propyloctadecyldimethyl ammonium chloride. Other examples of organosilicone compounds may be described in U.S. Pat. No. 3,719,697 to Michael, et al.; U.S. Pat. No. 3,730,701 to Isquith, et al.; U.S. Pat. No. 4,395,454 to Klein; U.S. Pat. No. 4,615,937 to Bouchette; and U.S. Pat. No. 6,136,770 to Cheung, et al., which are incorporated herein in their entirety by reference thereto for all purposes.

In addition to those mentioned above, still other biocides may also be employed in the present invention. For example, in some embodiments, the biocide may be a surfactant having antimicrobial efficacy. One such surfactant includes an alkoxylated amine, which is a nonionic surfactant. Examples of such surfactants include, for instance, ethoxylated alkyl amines, propoxylated alkyl amines, ethoxylated propoxylated alkyl amine, ethoxylated propoxylated quaternary ammonium compounds, alkyl ether amine alkoxylates, alkyl propoxyamine alkoxylates, alkylalkoxy ether amine alkoxylates, and so forth. Another suitable type of biocidal, nonionic surfactant includes alkyl glycosides. Alkyl glycosides are broadly defined as condensation products of long chain alcohols (e.g., C₈₋₃₀ alcohols) and a saccharide. Examples of long chain alcohols from which the alkyl group may include, but are not limited to, decyl alcohol, cetyl alcohol, stearyl alcohol, lauryl alcohol, myristyl alcohol, oleyl alcohol, and so forth. Alkyl glycosides are generally represented by the following formula:
(Z)ₙ-O—R

wherein,

Z is a saccharide residue;

n is from about 1 to about 1000; and

R is an alkyl group having 8 to 30 carbon atoms.

The “Z” saccharide residue of the alkyl glycoside typically has at least 3 carbon atoms, and in some embodiments, from about 3 to about 20 carbon atoms, and in some embodiments from about 5 to about 6 carbon atoms. The saccharide residue may, for instance, be a residue of glucose, fructose, maltose, maltotriose, lactose, galactose, mannose, dextrose, xylose, sucrose, leucrose, and so forth. The designation “n” represents the average number of saccharide residues in a particular sample of alkyl polyglycoside. For example, the alkyl glycoside may be a monosaccharide (n=1), disaccharide (n=2), trisaccharide (n=3), oligosaccharide (n=4 to 20), or polysaccharide (n>20). In most embodiments, “n” is greater than about 2, in some embodiments from about 2 to about 6, and in some embodiments, from about 2 to about 4. The “alkyl group” of the alkyl glycosides is generally a linear alkyl group (i.e., a straight chain alcohol residue), which typically has an even number of carbon atoms. The alkyl glycosides desirably include alkyl groups having 8 to 20 carbon atoms, in some embodiments 8 to 14, and in some embodiments, 9 to 12. One particular example of a suitable alkyl glycoside is a mixture of alkyl glycoside molecules with alkyl chains having 8 to 10 carbon atoms.

The alkyl glycoside may include a single type of alkyl glycoside molecule or a mixture of different alkyl glycoside molecules. The different alkyl glycoside molecules may be isomeric and/or may be alkyl glycoside molecules with differing alkyl groups and/or saccharide residues. Alkyl glycoside isomers are alkyl polyglycosides which, although including the same alkyl ether residues, may vary with respect to the location of the alkyl ether residue in the alkyl glycoside, as well as isomers which differ with respect to the orientation of the functional groups about one or more chiral centers in the molecules. For example, an alkyl glycoside may include a mixture of molecules with saccharide residues that are mono-, di- or oligosaccharides derived from more than one 6 carbon saccharide residue and in which the mono-, di- or oligosaccharide has been etherified by reaction with a mixture of fatty alcohols of varying carbon chain length. When more than one saccharide residue is present on average per alkyl glycoside molecule (i.e., “n” is greater than 1), the individual saccharide subunits within the same molecule may be identical or different. When the individual subunits are not all identical, the order and distribution of subunits is typically random.

Alkyl glycosides may be produced using well-known techniques. Alkyl mono and polyglycosides are generally prepared by reacting a monosaccharide, or a compound hydrolyzable to a monosaccharide, with an alcohol such as a fatty alcohol in an acid medium. For example, U.S. Pat. Nos. 5,527,892 and 5,770,543, which are incorporated herein in their entirety by reference thereto for all purposes, describe alkyl glycosides and/or methods for their preparation. Commercially available examples of suitable alkyl glycosides include Glucopon™ 220, 225, 425, 600 and 625, all of which are available from Cognis Corp. of Cincinnati, Ohio. These products are mixtures of alkyl mono- and oligoglucopyranosides with alkyl groups based on fatty alcohols derived from coconut and/or palm kernel oil. Glucopon™ 220, 225 and 425 are examples of particularly suitable alkyl polyglycosides. Glucopon™ 220 is an alkyl polyglycoside that contains an average of 1.4 glucosyl residues per molecule and a mixture of 8 and 10 carbon alkyl groups (average carbons per alkyl chain-9.1). Glucopon™ 225 is a related alkyl polyglycoside with linear alkyl groups having 8 or 10 carbon atoms (average alkyl chain-9.1 carbon atoms) in the alkyl chain. Glucopon™ 425 includes a mixture of alkyl polyglycosides that individually include an alkyl group with 8, 10, 12,14 or 16 carbon atoms (average alkyl chain-1 0.3 carbon atoms). Glucopon∩ 600 includes a mixture of alkyl polyglycosides that individually include an alkyl group with 12, 14 or 16 carbon atoms (average alkyl chain 12.8 carbon atoms). Glucopon™ 625 includes a mixture of alkyl polyglycosides that individually include an alkyl group having 12, 14 or 18 carbon atoms (average alkyl chain 12.8 carbon atoms). Still other suitable alkyl glycosides are available from Dow Chemical Co. of Midland, Mich. under the Triton™ designation, e.g., Triton™ CG-110 and BG-10.

Particularly preferred biocides for use in the present invention are cetyl pyridinium chloride (“CPC”) and polyhexamethylene biguanide (“PHMB”). Polyhexamethylene biguanide is believed to disrupt the cytoplasmic membrane of microorganisms, thus causing leakage of the low molecular weight cytoplasmic component. Likewise, cetyl pyridinium chloride is a cationic quaternary ammonium compound that is believed to induce leakage of potassium and pentose materials from microorganisms (e.g., S. cerevisiae), as well as protoplast lysis. The structure of cetyl pyridinium chloride is set forth below:

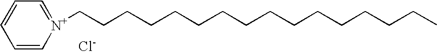

Sugar alcohols, also known as polyols or polyhydric alcohols, are hydrogenated forms of sugars that may be modified into compounds that retain the basic configuration of saccharides, but with different functional groups. Suitable sugar alcohols may include pentose alcohols (e.g., D-xylitol, D-arabitol, meso-ribitol (adonitol), and isomers thereof) and hexose alcohols (e.g., glycerol, meso-galacitol (dulcitol), inositol, D-mannitol, D-sorbitol, and isomers thereof). Pentose alcohols, for instance, have the same linear structure as pentoses, but are modified with one on or more alcohol groups. As an example, the Fischer open chain structures of D-xylitol, D-arabitol, and adonitol are set forth below:

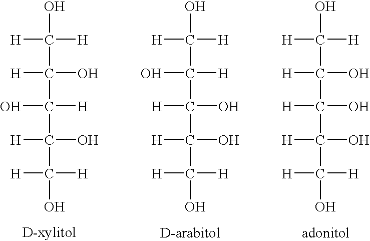

As stated above, the present inventors believe that the sugar alcohols increase the attraction of the antimicrobial agent to the microorganisms (e.g., the cytoplasmic membrane of bacteria), and thus increase the efficiency of microorganism inhibition. In addition, certain sugar alcohols may also provide independent inhibition of the growth of microorganisms. For example, exogenous D-xylitol is metabolized to glucose and glucogen or pyruvate and lactate in the liver. Many bacteria are unable to utilize xylitol as an energy source, and as such, its presence may be harmful to some bacteria despite the availability of an alternative energy source, such as glucose. For instance, it is known that xylitol may reduce the growth of Streptococcus mutans, Streptococcus salivarius, Streptococcus sanguis, Lactobacillus casei and some strains of Escherichia coli, Saccharomyces cerevisae and Salmonella typhii. Although the anti-microbiological mechanism of xylitol is not fully understood, the present inventors believe that xylitol may be transported into a pathogen to disrupt its metabolic process and/or gene expression capabilities. For instance, xylitol may be phosphorylated through the constitutive fructose phosphotransferase system that regulates many metabolic processes and gene expression in bacteria. In addition, because bacteria adhere to host cells through carbohydrate-binding proteins, extracellular xylitol may also disturb the binding process by acting as a receptor analogue for the host cell, which could result in decreased adherence.

The antimicrobial composition may optionally include additional ingredients to impart various benefits. For instance, the antimicrobial composition may also employ surfactants, other than any optional biocidal surfactants, to enhance the wettability of the composition on a substrate, to help emulsify or dissolve other ingredients, to increase viscosity, etc. When utilized, the amount of the surfactants utilized in the antimicrobial composition may generally vary depending on the relative amounts of the other components present within the composition. The surfactants may include nonionic surfactants, such as ethoxylated alkylphenols, ethoxylated and propoxylated fatty alcohols, ethylene oxide-propylene oxide block copolymers, ethoxylated esters of fatty (C₈-C₁₈) acids, condensation products of ethylene oxide with long chain amines or amides, condensation products of ethylene oxide with alcohols, and mixtures thereof. Various specific examples of suitable nonionic surfactants include, but are not limited to, methyl gluceth-10, PEG-20 methyl glucose distearate, PEG-20 methyl glucose sesquistearate, C₁₁₋₁₅ pareth-20, ceteth-8, ceteth-12, dodoxynol-12, laureth-15, PEG-20 castor oil, polysorbate 20, steareth-20, polyoxyethylene-10 cetyl ether, polyoxyethylene-10 stearyl ether, polyoxyethylene-20 cetyl ether, polyoxyethylene-1 0 oleyl ether, polyoxyethylene-20 oleyl ether, an ethoxylated nonylphenol, ethoxylated octylphenol, ethoxylated dodecylphenol, or ethoxylated fatty (C₆-C₂₂) alcohol, including 3 to 20 ethylene oxide moieties, polyoxyethylene-20 isohexadecyl ether, polyoxyethylene-23 glycerol laurate, polyoxy-ethylene-20 glyceryl stearate, PPG-10 methyl glucose ether, PPG-20 methyl glucose ether, polyoxyethylene-20 sorbitan monoesters, polyoxyethylene-80 castor oil, polyoxyethylene-1 5 tridecyl ether, polyoxy-ethylene-6 tridecyl ether, laureth-2, laureth-3, laureth-4, PEG-3 castor oil, PEG 600 dioleate, PEG 400 dioleate, and mixtures thereof.

Ionic surfactants (i.e., anionic, cationic, or amphoteric surfactants) may also be employed in the antimicrobial composition. For instance, one class of amphoteric surfactants that may be used are derivatives of secondary and tertiary amines having aliphatic radicals that are straight chain or branched, wherein one of the aliphatic substituents contains from about 8 to 18 carbon atoms and at least one of the aliphatic substituents contains an anionic water-solubilizing group, such as a carboxy, sulfonate, or sulfate group. Some examples of amphoteric surfactants include, but are not limited to, sodium 3-(dodecylamino)propionate, sodium 3-(dodecylamino)-propane-1-sulfonate, sodium 2-(dodecylamino)ethyl sulfate, sodium 2-(dimethylamino)octadecanoate, disodium 3-(N-carboxymethyl-dodecylamino) propane-1-sulfonate, disodium octadecyliminodiacetate, sodium 1-carboxymethyl-2-undecylimidazole, and sodium N,N-bis(2-hydroxyethyl)-2-sulfato-3-dodecoxypropylamine. Additional classes of amphoteric surfactants include phosphobetaines and the phosphitaines. For instance, some examples of such amphoteric surfactants include, but are not limited to, sodium coconut N-methyl taurate, sodium oleyl N-methyl taurate, sodium tall oil acid N-methyl taurate, sodium palmitoyl N-methyl taurate, cocodimethylcarboxymethylbetaine, lauryidimethylcarboxymethylbetaine, lauryldimethylcarboxyethylbetaine, cetyldimethylcarboxymethylbetaine, lauryl-bis-(2-hydroxyethyl)-carboxymethylbetaine, oleyldimethylgammacarboxypropylbetaine, lauryl-bis-(2-hydroxypropyl)-carboxyethylbetaine, cocoamidodimethylpropylsultaine, stearylamidod imethyl propylsultaine, laurylamido-bis-(2-hydroxyethyl)-propylsultaine, di-sodium oleamide PEG-2 sulfosuccinate, TEA oleamido PEG-2 sulfosuccinate, disodium oleamide MEA sulfosuccinate, disodium oleamide MIPA sulfosuccinate, disodium ricinoleamide MEA sulfosuccinate, disodium undecylenamide MEA sulfosuccinate, disodium wheat germamido MEA sulfosuccinate, disodium wheat germamido PEG-2 sulfosuccinate, disodium isostearamideo MEA sulfosuccinate, cocoamphoglycinate, cocoamphocarboxyglycinate, lauroamphoglycinate, lauroamphocarboxyglycinate, capryloamphocarboxyglycinate, cocoamphopropionate, cocoamphocarboxypropionate, lauroamphocarboxypropionate, capryloamphocarboxypropionate, dihydroxyethyl tallow glycinate, cocoamido disodium 3-hydroxypropyl phosphobetaine, lauric myristic amido disodium 3-hydroxypropyl phosphobetaine, lauric myristic amido glyceryl phosphobetaine, lauric myristic amido carboxy disodium 3-hydroxypropyl phosphobetaine, cocoamido propyl monosodium phosphitaine, lauric myristic amido propyl monosodium phosphitaine, and mixtures thereof.

Moreover, exemplary anionic surfactants include alkyl sulfates, alkyl ether sulfates, alkyl ether sulfonates, sulfate esters of an alkylphenoxy polyoxyethylene ethanol, α-olefin sulfonates, β-alkoxy alkane sulfonates, alkyl sulfonates, alkyl monoglyceride sulfates, alkyl monoglyceride sulfonates, alkyl carbonates, alkyl ether carboxylates, fatty acids, sulfosuccinates, sarcosinates, octoxynol or nonoxynol phosphates, taurates, fatty taurides, fatty acid amide polyoxyethylene sulfates, isethionates, or mixtures thereof. Particular examples of anionic surfactants include, but are not limited to, C₈-C₁₈ alkyl sulfates, C₈-C₁₈ fatty acid salts, C₈-C₁₈ alkyl ether sulfates having one or two moles of ethoxylation, C₈-C₁₈ alkamine oxides, C₈-C₁₈ alkoyl sarcosinates, C₈-C₁₈ sulfoacetates, C₈-C₁₈ sulfosuccinates, C8-C₁₈ alkyl diphenyl oxide disulfonates, C₈-C₁₈ alkyl carbonates, C₈-C₁₈ alpha-olefin sulfonates, methyl ester sulfonates, and blends thereof. The C₈-C₁₈ alkyl group may be straight chain (e.g., lauryl) or branched (e.g., 2-ethylhexyl). The cation of the anionic surfactant may be an alkali metal (e.g., sodium or potassium), ammonium, C₁-C₄ alkylammonium (e.g., mono-, di-, tri-), or C₁-C₃ alkanolammonium (e.g., mono-, di-, tri). More specifically, such anionic surfactants may include, but are not limited to, lauryl sulfates, octyl sulfates, 2-ethylhexyl sulfates, lauramine oxide, decyl sulfates, tridecyl sulfates, cocoates, lauroyl sarcosinates, lauryl sulfosuccinates, linear C₁₀ diphenyl oxide disulfonates, lauryl sulfosuccinates, lauryl ether sulfates (1 and 2 moles ethylene oxide), myristyl sulfates, oleates, stearates, tallates, ricinoleates, cetyl sulfates, and similar surfactants.

The antimicrobial composition may also contain a preservative or preservative system to inhibit the growth of microorganisms over an extended period of time. Suitable preservatives may include, for instance, alkanols, disodium EDTA (ethylenediamine tetraacetate), EDTA salts, EDTA fatty acid conjugates, isothiazolinone, benzoic esters (parabens) (e.g., methylparaben, propylparaben, butylparaben, ethylparaben, isopropylparaben, isobutylparaben, benzylparaben, sodium methylparaben, and sodium propylparaben), benzoic acid, propylene glycols, sorbates, urea derivatives (e.g., diazolindinyl urea), and so forth. Other suitable preservatives include those sold by Sutton Labs, such as “Germall 115” (amidazolidinyl urea), “Germall II” (diazolidinyl urea), and “Germall Plus” (diazolidinyl urea and iodopropynyl butylcarbonate). Another suitable preservative is Kathon CG®, which is a mixture of methylchloroisothiazolinone and methylisothiazolinone available from Rohm & Haas; Mackstat H 66 (available from Mcintyre Group, Chicago, Ill.). Still another suitable preservative system is a combination of 56% propylene glycol, 30% diazolidinyl urea, 11% methylparaben, and 3% propylparaben available under the name GERMABEN® II from International Specialty Products of Wayne, N.J. In one particular embodiment of the present invention, benzoic acid is employed as a preservative due to its broad efficacy against a wide variety of organisms, lack of odor, and optimal performance at the low pH values often employed for the antimicrobial composition (e.g., from about 2.5 to about 5.5).

The pH of the antimicrobial composition may also be controlled within a range that is considered more biocompatible. For instance, it is typically desired that the pH is within a range of from about 3 to about 9, in some embodiments from about 4 to about 8, and in some embodiments, from about 5 to about 7. Various pH modifiers may be utilized in the antimicrobial composition to achieve the desired pH level. Some examples of pH modifiers that may be used in the present invention include, but are not limited to, mineral acids, sulfonic acids (e.g., 2-[N-morpholino] ethane sulfonic acid), carboxylic acids, and polymeric acids. Specific examples of suitable mineral acids are hydrochloric acid, nitric acid, phosphoric acid, and sulfuric acid. Specific examples of suitable carboxylic acids are lactic acid, acetic acid, citric acid, glycolic acid, maleic acid, gallic acid, malic acid, succinic acid, glutaric acid, benzoic acid, malonic acid, salicylic acid, gluconic acid, and mixtures thereof. Specific examples of suitable polymeric acids include straight-chain poly(acrylic) acid and its copolymers (e.g., maleic-acrylic, sulfonic-acrylic, and styrene-acrylic copolymers), cross-linked polyacrylic acids having a molecular weight of less than about 250,000, poly(methacrylic) acid, and naturally occurring polymeric acids such as carageenic acid, carboxymethyl cellulose, and alginic acid. Basic pH modifiers may also be used in some embodiments of the present invention to provide a higher pH value. Suitable pH modifiers may include, but are not limited to, ammonia; mono-, di-, and tri-alkyl amines; mono-, di-, and tri-alkanolamines; alkali metal and alkaline earth metal hydroxides; alkali metal and alkaline earth metal silicates; and mixtures thereof. Specific examples of basic pH modifiers are ammonia; sodium, potassium, and lithium hydroxide; sodium, potassium, and lithium meta silicates; monoethanolamine; triethylamine; isopropanolamine; diethanolamine; and triethanolamine. When utilized, the pH modifier may be present in any effective amount needed to achieve the desired pH level.

To better enhance the benefits to consumers, other optional ingredients may also be used. For instance, some classes of ingredients that may be used include, but are not limited to: antioxidants (product integrity); anti-reddening agents, such as aloe extract; astringents--cosmetic (induce a tightening or tingling sensation on skin); colorants (impart color to the product); deodorants (reduce or eliminate unpleasant odor and protect against the formation of malodor on body surfaces); fragrances (consumer appeal); opacifiers (reduce the clarity or transparent appearance of the product); skin conditioning agents; skin exfoliating agents (ingredients that increase the rate of skin cell turnover such as alpha hydroxy acids and beta hydroxyacids); skin protectants (a drug product which protects injured or exposed skin or mucous membrane surface from harmful or annoying stimuli); and thickeners (to increase the viscosity of the composition).

The antimicrobial composition of the invention may be used in a variety of applications, e.g., to reduce microbial or viral populations on a surface. The antimicrobial composition may be topically applied to the surface, such as to a hard surface (e.g., e.g., sink, table, counter, sign, and so forth) or to a user/patient (e.g., skin, mucosal membrane, such as in the mouth, nasal passage, stomach, vagina, etc., wound site, surgical site, and so forth). The composition may also be administered in a variety of forms, such as a lotion, cream, jelly, liniment, ointment, salve, oil, emulsion, foam, gel, film, wash, coating, liquid, capsule, tablet, etc. In one embodiment, for example, the antimicrobial composition is topically administered in the form of a “gel”, which is a colloid in which a disperse phase combines with a dispersion medium to produce a jelly-like, solid or semi-solid material. Although a variety of compounds may be employed, water is usually employed as the dispersion medium for the gel to optimize biocompatibility. Other possible dispersion mediums include non-aqueous solvents, including glycols, such as propylene glycol, butylene glycol, triethylene glycol, hexylene glycol, polyethylene glycols, ethoxydiglycol, and dipropyleneglycol; alcohols, such as ethanol, n-propanol, and isopropanol; triglycerides; ethyl acetate; acetone; triacetin; and combinations thereof.

The disperse phase of the gel may be formed from any of a variety of different gelling agents, including temperature responsive (“thermogelling”) compounds, ion responsive compounds, and so forth. Thermogelling systems, for instance, respond to a change in temperature (e.g., increase in temperature) by changing from a liquid to a gel. Any of a variety of thermogelling compounds may be used in the present invention. In some cases, thermogelling block copolymers, graft copolymers, and/or homopolymers may be employed. For example, polyoxyalkylene block copolymers may be used in some embodiments of the present invention to form a thermo-gelling composition. The term “polyoxyalkylene block copolymers” refers to copolymers of alkylene oxides, such as ethylene oxide and propylene oxide, which form a gel when dispersed in water in a sufficient concentration. Some suitable polyoxyalkylene block copolymers include polyoxybutylene block copolymers and polyoxyethylene/polyoxypropylene block copolymers (“EO/PO” block copolymers), such as described in U.S. Patent Application Publication No. 2003/0204180 to Huang, et al., which is incorporated herein in its entirety by reference thereto for all purposes. For instance, exemplary polyoxyalkylene block copolymers include polyoxyethylene/polyoxypropylene block copolymers (EO/PO block copolymers) having the following general formula:
HO(CH₂CH₂O)ₓ(CH(CH₃)CH₂O)_{y}(CH₂CH₂—)_{z}H

wherein,

x, y, and z are each integers in the range of about 10 to about 150.

The polyoxyethylene chain of such block copolymers typically constitutes at least about 60 wt. %, in some embodiments at least about 70 wt. % of the copolymer. Further, the copolymer typically has a total average molecular weight of at least about 5000, in some embodiments at least about 10,000, and in some embodiments, at least about 15,000. Suitable EO/PO polymers for use in the antimicrobial composition of the present invention are commercially available under the trade name PLURONIC® (e.g., F-127 L-122, L-92, L-81, and L-61) from BASF Corporation, Mount Olive, N.J.

Of course, any other thermogelling compound may also be used in the present invention. For example, other suitable thermogelling polymers may include homopolymers, such as poly(N-methyl-N-n-propylacrylamide), poly(N-n-propylacrylamide), poly(N-methyl-N-isopropylacrylamide), poly(N-n-propylmethacrylamide), poly(N-isopropylacrylamide), poly(N,n-diethylacrylamide); poly(N-isopropylmethacrylamide), poly(N-cyclopropylacrylamide), poly(N-ethylmethyacrylamide), poly(N-methyl-N-ethylacrylamide), poly(N-cyclopropylmethacrylamide), and poly(N-ethylacrylamide). Still other examples of suitable thermogelling polymers may include cellulose ether derivatives, such as hydroxypropyl cellulose, methyl cellulose, hydroxypropylmethyl cellulose, and ethylhydroxyethyl cellulose. Moreover thermogelling polymers may be made by preparing copolymers between (among) monomers, or by combining such homopolymers with other water-soluble polymers, such as acrylic monomers (e.g., acrylic or methacrylic acid, acrylate or methacrylate, acrylamide or methacrylamide, and derivatives thereof).

Ion responsive gelling compounds are also suitable for use in the present invention. Such compounds are generally well known in the art, and tend to form a gel in the presence of certain ions or at a certain pH. For instance, one suitable class of ion responsive compounds that may be employed in the present invention is anionic polysaccharides. Anionic polysaccharides may form a three-dimensional polymer network that functions as the disperse phase of the gel. Generally speaking, anionic polysaccharides include polysaccharides having an overall anionic charge, as well as neutral polysaccharides that contain anionic functional groups. For instance, some suitable examples of gel-forming anionic polysaccharides include natural gums, such as gellan gum and alginate gums (e.g., ammonium and alkali metal of salts of alginic acid); chitosan; carboxymethylcellulose, pectins, carrageenan, xantham gum, and derivatives or salts thereof. The particular type of anionic polysaccharide selected will depend, in part, on the nature of the antimicrobial composition and the other components used therein. For example, carrageenan is sensitive to particular types of cations, e.g., it typically gels in the presence of potassium but not sodium. Glycuronans, likewise, typically gel in the presence of divalent cations (e.g., Ca²⁺), but not monovalent cations (e.g., Na⁺). Xanthan gum may gel in the presence of divalent cations, but only at a relatively high pH.

The amount of the antimicrobial agent(s) and sugar alcohol(s) employed in the composition of the present invention depends on a variety of factors, including the nature of the antimicrobial agent and sugar alcohol, the type and relative amounts of the other components present within the composition, the pick-up of the application method utilized, the intended application, and so forth. Typically, the amount of the antimicrobial agent(s) is relatively low in comparison to the sugar alcohol(s) to enhance the biocompatibility and cost-effectiveness of the composition. For example, the weight ratio of the sugar alcohol(s) to the antimicrobial agent(s) may range from about 1:1 to about 5000:1, in some embodiments from about 2:1 to about 1000:1, and in some embodiments, from about 10:1 to about 500:1. Nevertheless, the actual amount of the antimicrobial agent(s) is sufficient to achieve the desired efficacy. For example, antimicrobial agent(s) may be present in an amount from about 0.001 wt. % to about 0.5 wt. %, in some embodiments from about 0.01 wt. % to about 0.4 wt. %, and in some embodiments, from about 0.05 wt. % to about 0.2 wt. % of the antimicrobial composition. Likewise, sugar alcohol(s) may be present in an amount from about 0.1 wt. % to about 20 wt. %, in some embodiments from about 0.5 wt. % to about 15 wt. %, and in some embodiments, from about 1 wt. % to about 10 wt. % of the antimicrobial composition. Other components in the composition (e.g., surfactants, preservatives or preservative systems, pH modifiers, gelling agents, etc.) may also individually constitute from about 0.01 wt. % to about 5 wt. %, in some embodiments from about 0.001 wt. % to about 1 wt. %, and in some embodiments, from about 0.1 wt. % to about 0.15 wt. % of the composition.

In some embodiments, the antimicrobial composition may also be applied to a substrate prior to use. The substrate may provide an increased surface area to facilitate contact of the antimicrobial composition with microorganisms. In addition, the substrate may also serve other purposes, such as providing water absorption, barrier properties, etc. Any of a variety of substrates may be applied with the antimicrobial composition in accordance with the present invention. For instance, nonwoven webs, woven fabrics, knit fabrics, paper, films, foams, elastomeric materials, etc., may be applied with the antimicrobial composition. The nonwoven web may, for instance, be a spunbond web, meltblown web, bonded carded web, airlaid web, coform web, hydraulically entangled web, etc. Polymers suitable for making nonwoven webs include, for example, polyolefins, polyesters, polyamides, polycarbonates, copolymers and blends thereof, etc. Most embodiments of the laminate of the present invention employ a nonwoven web formed from olefin-based polymers, which are non-polar in nature. Suitable polyolefins include polyethylene, such as high density polyethylene, medium density polyethylene, low density polyethylene, and linear low density polyethylene; polypropylene, such as isotactic polypropylene, atactic polypropylene, and syndiotactic polypropylene; polybutylene, such as poly(1-butene) and poly(2-butene); polypentene, such as poly(1-pentene) and poly(2-pentene); poly(3-methyl-1-pentene); poly(4-methyl-1-pentene); and copolymers and blends thereof. Suitable copolymers include random and block copolymers prepared from two or more different unsaturated olefin monomers, such as ethylene/propylene and ethylene/butylene copolymers. It should be noted that the polymer(s) may also contain other additives, such as processing aids or antimicrobial compositions to impart desired properties to the fibers, residual amounts of carriers, pigments or colorants, and so forth.

If desired, the nonwoven web may have a multi-layer structure. Suitable multi-layered materials may include, for instance, spunbond/meltblown/spunbond (SMS) laminates and spunbond/meltblown (SM) laminates. Various examples of suitable SMS laminates are described in U.S. Pat. No. 4,041,203 to Brock et al.; U.S. Pat. No. 5,213,881 to Timmons, et al.; U.S. Pat. No. 5,464,688 to Timmons, et al.; U.S. Pat. No. 4,374,888 to Bornslaeger; U.S. Pat. No. 5,169,706 to Collier, et al.; and U.S. Pat. No. 4,766,029 to Brock et al., which are incorporated herein in their entirety by reference thereto for all purposes. In addition, commercially available SMS laminates may be obtained from Kimberly-Clark Corporation under the designations Spunguard® and Evolution®.

The nonwoven web may also contain an additional fibrous component so that it is considered a composite. For example, a nonwoven web may be entangled with another fibrous component using any of a variety of entanglement techniques known in the art (e.g., hydraulic, air, mechanical, etc.). In one embodiment, the nonwoven web is integrally entangled with cellulosic fibers using hydraulic entanglement. A typical hydraulic entangling process utilizes high pressure jet streams of water to entangle fibers to form a highly entangled consolidated fibrous structure, e.g., a nonwoven fabric. Hydraulically entangled nonwoven fabrics of staple length and continuous fibers are disclosed, for example, in U.S. Pat. No. 3,494,821 to Evans and U.S. Pat. No. 4,144,370 to Boulton, which are incorporated herein in their entirety by reference thereto for all purposes. Hydraulically entangled composite nonwoven fabrics of a continuous fiber nonwoven web and a pulp layer are disclosed, for example, in U.S. Pat. No. 5,284,703 to Everhart, et al. and U.S. Pat. No. 6,315,864 to Anderson, et al., which are incorporated herein in their entirety by reference thereto for all purposes. The fibrous component of the composite may contain any desired amount of the resulting substrate. The fibrous component may contain greater than about 50% by weight of the composite, and in some embodiments, from about 60% to about 90% by weight of the composite. Likewise, the nonwoven web may contain less than about 50% by weight of the composite, and in some embodiments, from about 10% to about 40% by weight of the composite.

Other materials may also be used to form the substrate. For example, the substrate may contain an elastomeric polymer, such as natural rubber latex, isoprene polymers, chloroprene polymers, vinyl chloride polymers, S-EB—S (styrene-ethylene-butylene-styrene) block copolymers, S—I—S (styrene-isoprene-styrene) block copolymers, S—B—S (styrene-butadiene-styrene) block copolymers, S—I (styrene-isoprene) block copolymers, S—B (styrene-butadiene) block copolymers, butadiene polymers, styrene-butadiene polymers, carboxylated styrene-butadiene polymers, acrylonitrile-butadiene polymers, carboxylated acrylonitrile-butadiene polymers, acrylonitrile-styrene-butadiene polymers, carboxylated acrylonitrile-styrene-butadiene polymers, derivatives thereof, and so forth. Suitable S-EB-S block copolymers, for instance, are described in U.S. Pat. No. 5,112,900 to Buddenhagen, et al.; U.S. Pat. No. 5,407,715 to Buddenhagen, et al.; U.S. Pat. No. 5,900,452 to Plamthottam; and U.S. Pat. No. 6,288,159 to Plamthottam, which are incorporated herein in their entirety by reference thereto for all purposes. Still other suitable elastomeric materials are described in U.S. Pat. No. 5,792,531 to Littleton, et al., which is incorporated herein in its entirety by reference thereto for all purposes.

The substrate may optionally be treated with liquid-repellency additives, antistatic agents, surfactants, colorants, antifogging agents, fluorochemical blood or alcohol repellents, lubricants, etc. In addition, certain substrates (e.g., SMS laminates) may also be subjected to an electret treatment. The electret treatment imparts an electrostatic charge to the substrate to improve its filtration efficiency. The charge may include layers of positive or negative charges trapped at or near the surface of the polymer, or charge clouds stored in the bulk of the polymer. The charge may also include polarization charges that are frozen in alignment of the dipoles of the molecules. Techniques for subjecting the substrate to an electret treatment are well known by those skilled in the art. Examples of such techniques include, but are not limited to, thermal, liquid-contact, electron beam and corona discharge techniques. In one particular embodiment, the electret treatment is a corona discharge technique, which involves subjecting the substrate to a pair of electrical fields that have opposite polarities. Other methods for forming an electret material are described in U.S. Pat. No. 4,215,682 to Kubik. et al.; U.S. Pat. No. 4,375,718 to Wadsworth; U.S. Pat. No. 4,592,815 to Nakao; U.S. Pat. No. 4,874,659 to Ando; 5,401,446 to Tsai, et al.; U.S. Pat. No. 5,883,026 to Reader, et al.; U.S. Pat. No. 5,908,598 to Rousseau, et al.; U.S. Pat. No. 6,365,088 to Knight, et al., which are incorporated herein in their entirety by reference thereto for all purposes.

Regardless of the type of substrate selected, the antimicrobial composition may be applied thereto using any of a variety of well-known application techniques. Suitable techniques for applying the composition to a substrate include printing, dipping, spraying, melt extruding, carrier coating, powder coating, and so forth. Although not necessarily required, the components of the antimicrobial composition are typically dissolved or dispersed in a carrier prior to facilitate application to the substrate. For example, one or more of the above-mentioned components may be mixed with a carrier, either sequentially or simultaneously, to facilitate application to the substrate. Any carrier capable of dispersing or dissolving the components is suitable, for example water; alcohols such as ethanol or methanol; dimethylformamide; dimethyl sulfoxide; hydrocarbons such as pentane, butane, heptane, hexane, toluene and xylene; ethers such as diethyl ether and tetrahydrofuran; ketones and aldehydes such as acetone and methyl ethyl ketone; acids such as acetic acid and formic acid; and halogenated carriers such as dichloromethane and carbon tetrachloride; as well as mixtures thereof. In one particular embodiment, for example, water is used as the carrier to optimize biocompatibility. Although the actual concentration of carrier (e.g., water) employed will generally depend on the other components employed, it is nonetheless typically present in an amount from about 75 wt. % to about 99 wt. %, in some embodiments from about 80 wt. % to about 98 wt. %, and in some embodiments, from about 85 wt. % to about 95 wt. % of the composition.

The antimicrobial composition may be incorporated within the matrix of the substrate and/or applied to the surface thereof. For example, in one embodiment, the antimicrobial composition is coated onto one or more surfaces of the substrate. When coated onto the substrate, the resulting thickness of the coating may be minimal so that it is almost invisible to the naked eye. For instance, the thickness of the coating may be less than about 2 micrometers, in some embodiments from about 2 to about 500 nanometers, and in some embodiments, from about 20 to about 200 nanometers. The percent coverage of the antimicrobial coating may also be selected to achieve the desired antimicrobial efficacy. Typically, the percent coverage is greater than about 50%, in some embodiments greater than about 80%, and in some embodiments, approximately 100% of the area of a given surface.

Upon application with the antimicrobial composition, the substrate is optionally dried to substantially remove the carrier. The amount of the resulting antimicrobial composition present on the dried substrate may vary depending on the nature of the substrate and its intended application. For example, the dry solids add-on level of the antimicrobial composition may be from about 0.001 % to about 20%, in some embodiments from about 0.01% to about 10%, and in some embodiments, from about 0.1% to about 4%. The “solids add-on level” is determined by subtracting the weight of the untreated substrate from the weight of the treated substrate (after drying), dividing this calculated weight by the weight of the untreated substrate, and then multiplying by 100%. Lower add-on levels may provide optimum functionality of the substrate, while higher add-on levels may provide optimum antimicrobial efficacy.

When treated with the antimicrobial composition in accordance with the present invention, the substrate may be used in a wide variety of articles. For example, the treated substrate may be incorporated into a “medical product”, such as surgical gowns, surgical drapes, facemasks, head coverings, surgical caps, shoe coverings, wound dressings, bandages, sterilization wraps, wipers, surgical gloves, dilatation balloons, inflatable cuffs, external catheters, catheter balloons, instrument covers, and so forth. In one particular embodiment, the antimicrobial composition may be applied to a barrier material (e.g., SMS fabric) of a medical product. Of course, the treated substrate may also be used in various other articles. For example, the treated substrate may be incorporated into a “personal care product”, such as diapers, training pants, swim pants, absorbent underpants, adult incontinence products, feminine hygiene products, and so forth.

The present inventors have discovered that the antimicrobial composition of the present invention may inhibit (e.g., reduce by a measurable amount or to prevent entirely) the growth of one or more microorganisms when exposed thereof. Examples of microorganisms that may be inhibited include bacteria (including cyanobacteria and Mycobacteria), lichens, microfungi, protozoa, virinos, viroids, viruses, fungi (e.g., molds and yeast), and some algae. For example, the antimicrobial composition may inhibit the growth of several medically significant bacteria groups, such as gram negative rods (e.g., Entereobacteria); gram negative curved rods (e.g., Heliobacter, Campylobacter, etc.); gram negative cocci (e.g., Neisseria); gram positive rods (e.g., Bacillus, Clostridium, etc.); gram positive cocci (e.g., Staphylococcus, Streptococcus, etc.); obligate intracellular parasites (e.g,. Ricckettsia and Chlamydia); acid fast rods (e.g., Myobacterium, Nocardia, etc.); spirochetes (e.g., Treponema, Borellia, etc.); and mycoplasmas (i.e., tiny bacteria that lack a cell wall). Particularly species of bacteria that may be inhibited with the antimicrobial composition of the present invention include E. coli (gram negative rod), Klebsiella pneumonia (gram negative rod), Streptococcus (gram positive cocci), Salmonella choleraesuis (gram negative rod), Staphyloccus aureus (gram positive cocci), and P. aeruginosa (gram negative rod). In addition to bacteria, other microorganisms of interest include molds (e.g., Aspergillus niger) and yeasts (e.g., Candida albicans), which belong to the Fungi kingdom.

Upon exposure for a certain period of time, the antimicrobial composition may provide a log reduction of at least about 2, in some embodiments at least about 3, in some embodiments at least about 4, and in some embodiments, at least about 5 (e.g., about 6). Log reduction, for example, may be determined from the % population killed by the composition according to the following correlations:

| % Reduction | Log Reduction |
|---|---|
| 90 | 1 |
| 99 | 2 |
| 99.9 | 3 |
| 99.99 | 4 |
| 99.999 | 5 |
| 99.9999 | 6 |

Such a log reduction may be achieved in accordance with the present invention after only a relatively short exposure time. For example, the desired log reduction may be achieved after exposure for only 30 minutes, in some embodiments 15 minutes, and in some embodiments, 10 minutes.

The present invention may be better understood with reference to the following examples.

### Reagents EmploVed in the Examples

S. aureus was obtained from the American Type Culture Collection (ATCC #6358). The culture medium was Trypticase soy agar (ATCC medium 18).

P. aeruginosa was obtained from the American Type Culture Collection (ATCC #9027). The culture medium was Nutrient broth (ATCC medium 3).

Cetyl pyridinium chloride (98% in water) was obtained from Sigma-Aldrich Chemical Co. of St. Louis, Mo.

Chlorhexidine gluconate (20% in water) was obtained from Sigma-Aldrich Chemical Co. of St. Louis, Mo.

Polyhexamethylene biguanide was obtained from Arch Chemicals, Inc. under the designations Cosmocil™ CQ (20 wt. % PHMB in water) or Vantocil™ (heterodisperse mixture of PHMB with a molecular weight of approximately 3,000).

Amine ethoxylate was obtained from Dow Chemical Corp. of Midland, Mich. under the designation Triton TM RW-50.

Xylitol was obtained from Danisco USA, Inc. of Ardsley, N.Y.

### EXAMPLE 1

The ability of an antimicrobial composition containing cetyl pyridinium chloride and xylitol to inhibit microbial growth was demonstrated. Initially, a microorganism culture of 10⁶ cfu (colony forming units) per milliliter in a 1× phosphate buffered saline (PBS) solution (diluted from 10×PBS LIQUID CONCENTRATE, which is available from VWR International under Cat. No. EM-6507] was used. The samples were dissolved into 9 milliliters of PBS and then filtering into a culture tubes. Upon formation, 1 milliliter of microorganism (at a concentration of around 10⁶ cfu/ml; diluted from 10⁸ cfu/ml stock) was added into culture tubes with control solutions (containing no cetyl pyridinium chloride and/or xylitol) or sample solutions (containing cetyl pyridinium chloride and xylitol). The culture tubes were shaken at 37° C. using a shaker. After 10 minutes, the solution samples were drawn and then diluted at 0.001× and 0.0001×. 1.0 milliliter of each solution was plated onto agar plates. The plates were incubated overnight at 35° C. The number of colonies on each plate was counted. All samples were plated in duplicated. The number of colonies was converted to a “log reduction” as set forth above. The results are set forth below in Table 1.

TABLE 1
Log Reduction of Samples

| | Cetyl | | | |
|---|---|---|---|---|
| | pyridinium | | | |
| | chloride | Xylitol | | |
| Sample | (wt. %) | (wt. %) | S. aureus | P. aeruginosa |
| A | 0.0050 | 0.0 | 3.00 | 3.00 |
| B | 0.0010 | 0.0 | 0.88 | 0.96 |
| C | 0.0005 | 0.0 | 0.23 | 0.00 |
| D | 0.0000 | 5.0 | 0.00 | 0.00 |
| E | 0.0000 | 10.0 | 0.00 | 0.00 |
| F | 0.0050 | 5.0 | 5.00 | 5.00 |
| G | 0.0010 | 5.0 | 4.00 | 3.00 |
| H | 0.0005 | 5.0 | 3.00 | 3.00 |
| I | 0.0050 | 10.0 | 5.00 | 5.00 |
| J | 0.0010 | 10.0 | 4.00 | 4.00 |
| K | 0.0005 | 10.0 | 4.00 | 3.00 |
| L | 0.0000 | 0.0 | 0.00 | 0.00 |

As shown, the combination of xylitol and cetyl pyridinium chloride provided the optimum antimicrobial efficacy in solution.

### EXAMPLE 2

Antimicrobial efficacy tests were performed as described in Example 1, except that chlorhexidine gluconate was used as the antimicrobial agent. The results are set forth below in Table 2.

TABLE 2
Log Reduction of Samples

| | Chlorhexidine | | | |
|---|---|---|---|---|
| | Gluconate | Xylitol | | |
| Sample | (wt. %) | (wt. %) | S. aureus | P. aeruginosa |
| A | 0.0050 | 0.0 | 0.71 | 3.00 |
| B | 0.0010 | 0.0 | 0.17 | 0.75 |
| C | 0.0005 | 0.0 | 0.00 | 0.00 |
| D | 0.0000 | 5.0 | 0.00 | 0.00 |
| E | 0.0050 | 5.0 | 4.00 | 4.00 |
| F | 0.0010 | 5.0 | 3.00 | 3.00 |
| G | 0.0005 | 5.0 | 3.00 | 3.00 |
| H | 0.0000 | 0.0 | 0.00 | 0.00 |

As shown, the combination of xylitol and chlorhexidine gluconate provided the optimum antimicrobial efficacy in solution.

### EXAMPLE 3

Antimicrobial efficacy tests were performed as described in Example 1, 15 except that amine ethoxylate was used as the antimicrobial agent. The results are set forth below in Table 3.

TABLE 3
Log Reduction of Samples

| | Amine | | | |
|---|---|---|---|---|
| | Ethoxylate | Xylitol | | |
| Sample | (wt. %) | (wt. %) | S. aureus | P. aeruginosa |
| A | 0.1 | 0.0 | 3.00 | 2.00 |
| B | 0.1 | 5.0 | 4.00 | 4.00 |
| C | 0.0 | 5.0 | 0.29 | 0.00 |
| D | 0.0 | 0.0 | 0.00 | 0.00 |

As shown, the combination of xylitol and amine ethoxylate provided the optimum antimicrobial efficacy.

### EXAMPLE 4

The ability of a treated substrate of the present invention to provide antimicrobial efficacy was demonstrated. Initially, a spunbond/meltblown/spunbond (“SMS”) nonwoven laminate was provided (available from Kimberly-Clark Corp) having a basis weight of 0.9 ounces per square yard and an orange color. For coating the substrates, 500 milliliters of an aqueous formulation was prepared that contained 0.5 wt % polyhexamethylene biguanide and 99.5 wt % water/hexanol. The aqueous formulation was thoroughly mixed for about 20 minutes using a lab stirrer (Stirrer RZR 50 from Caframo Ltd., Wiarton, Ontario, Canada). After mixing, it was poured into a glass pan. Then, an 8″×11″ hand sheet substrate was immersed into the bath for saturation. Full substrate saturation was achieved when the substrate turned translucent. After full saturation, the substrate was nipped between two rollers (one stationary roller and one rotating roller) of a laboratory wringer No. LW-849, Type LW-1 made by Atlas Electrical Device Co., Chicago, Ill. After the sample was nipped and passed through the rollers, excess saturant was removed and the wet weight (W_{w}) was measured immediately using a Mettler PE 360 balance. The saturated and nipped sample was then placed in on oven for drying at about 80° C. for about 30 minutes or until a constant weight was reached. After drying, the weight of the treated and dried sample (W_{d}) is measured. The amount of treatment on the substrate was measured gravimetrically by first calculating the percent wet pick-up (% WPU) using the following equation:
% WPU=([W_{w}−W_{d}]/W_{d})×100

Then, the percent add-on was calculated using the following equation:
% Add-on =% WPU x bath concentration (wt %)

At a given bath concentration, the % WPU can be varied to a certain extent by varying the nip pressure of the laboratory wringer. Generally the higher the nip pressure, the more saturant (or treating composition) is squeezed out of the substrate the lower is the % WPU and the lower is the final add-on on the substrate. After treating, the samples were tested using the “Dynamic Shaker Flask” test to quickly screen different antimicrobial combinations for synergistic effects. The experimental procedure is based on ASTM E 2149-01. The test was performed by first adding a 2″×2″ sample of treated material to a flask containing 50 mL of a buffered-saline solution. The flask was then inoculated with the challenge organism (6.0-7 log₁₀ total) and shaken through mechanical means for a designated period of time. At specified time points, a sample of the solution was then removed and plated. Lastly, the plate was incubated, examined for microbial growth, and the number of colony forming units counted. The log reduction in organisms was measured by comparing the growth on the experimental plate to control plates with no antimicrobial treatment.

The number of colonies was converted to a “log reduction” as set forth above. The 15 minutes of Dynamic Shaker Flask testing results are set forth below in Table 4.

TABLE 4
Log Reduction of Samples - 15 minutes

| | Antimicrobial Composition | | | |
|---|---|---|---|---|
| | Polyhexamethylene | | | |
| | biguanide | Xylitol | | |
| Sample | (wt. %) | (wt. %) | S. aureus | P. aeruginosa |
| A | 0.1 | 0.0 | 0.58 | 0.34 |
| B | 0.1 | 0.1 | 0.94 | 4.00 |
| C | 0.1 | 1.5 | 1.52 | 4.00 |
| D | 0.1 | 3.0 | 4.00 | 4.00 |
| E | 0.0 | 0.0 | 0.00 | 0.00 |

As shown, Sample A (containing PHMB) achieved only a small log reduction of S. aureus and P. aeruginosa after 15 minutes in comparison to Samples B-D, which contained a combination of xylitol and polyhexamethylene biguanide.

### EXAMPLE 5

Treated SMS fabrics were tested as described in Example 4, except that no polyhexamethylene biguanide was employed. The results are set forth below in Table 5.

TABLE 5
Log Reduction of Samples

| | Antimicrobial Composition | | | |
|---|---|---|---|---|
| | Polyhexamethylene | | | |
| | biguanide | Xylitol | | |
| Sample | (wt. %) | (wt. %) | S. aureus | P. aeruginosa |
| A | 0.0 | 0.1 | 0 | 0 |
| B | 0.0 | 1.5 | 0 | 0 |
| C | 0.0 | 3.0 | 0 | 0 |
| D | 0.0 | 5.0 | 0 | 0 |
| E | 0.0 | 10.0 | 0 | 0 |
| F | 0.0 | 0.0 | 0 | 0 |

As shown, the use of xylitol alone did not provide sufficient antimicrobial efficacy.

### EXAMPLE 6

Treated SMS fabrics were tested as described in Example 4, except that cetyl pyridinium chloride was employed instead of polyhexamethylene biguanide. The 10 minutes of Dynamic Shaker Flask testing results are set forth below in Table 6.

TABLE 6
Log Reduction of Samples - 10 minutes

| | Cetyl | | | |
|---|---|---|---|---|
| | pyridinium | | | |
| | chloride | Xylitol | | |
| Sample | (wt. %) | (wt. %) | S. aureus | P. aeruginosa |
| A | 0.1 | 0.0 | 3.00 | 3.00 |
| B | 0.1 | 5.0 | 4.00 | 5.00 |
| C | 0.0 | 5.0 | 0.29 | 0.00 |
| D | 0.0 | 0.0 | 0.00 | 0.00 |

### EXAMPLE 7

To assess whether the applied antimicrobial coating on the materials was stable and did not leach from the substrate surface, two tests are employed. First, according to the American Association of Textile Chemists and Colorists (AATCC)-147 test protocol, in a dry-leaching test, the antimicrobial treated material was placed in an agar plate seeded with a known amount of organism population on the plate surface. The plate was then incubated for about 18-24 hours at about 35° C. or 37° C.±2° C. Afterwards, the agar plate was examined for any indicia of inhibition of microbial activity or growth, which would indicate leaching of the antimicrobial agent. Second, in a wet-leaching zone of inhibition test, according to the American Society for Testing and Materials (ASTM) E 2149-01 test protocol involving a dynamic shake flask, several pieces of an antimicrobial-coated substrate were placed in a 0.3 mM solution of phosphate (KH₂PO₄) at buffer pH of about 6.8. The piece of material was allowed to sit for 24 hours in solution and then the supernatant of the solution was extracted. The extraction conditions involved where about 30 minutes at room temp (˜23° C.) with 50 ml of buffer in a 250 ml Erlenmeyer flask. The flask was shaken in a wrist shaker for 1 hour ±5 minutes. About 100 microliters (μL) of supernatant was added to a 8-mm well cut into a seeded agar plate and allow to dry. After about 24 hours at 35° C.±2° C., the agar plate was examined for any indicia of inhibition of microbial activity or growth.

The above-described leaching tests were performed for two of the treated SMS samples of Example 4. The results are shown below in Table 7.

TABLE 7
Leaching Test Results

| | AATCC | ASTM |
|---|---|---|
| 1.0 wt. % Polyhexamethylene biguanide | 0 | 0 |
| 0.1 wt. % Polyhexamethylene biguanide | 0 | 0 |
| 3.0 wt. % Xylitol | | |

As indicated above, no antimicrobial agent leaching was detected.

While the invention has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. An antimicrobial composition comprising one or more antimicrobial agents in an amount of from about 0.001 wt. % to about 0.5 wt. % and one or more sugar alcohols in an amount from about 0.1 wt. % to about 20 wt. %, wherein the sugar alcohols are selected from the group consisting of pentose alcohols and hexose alcohols.

2. The antimicrobial composition of claim 1, wherein the antimicrobial agents constitute from about 0.01 wt. % to about 0.4 wt. % of the antimicrobial composition.

3. The antimicrobial composition of claim 1, wherein the antimicrobial agents constitute from about 0.05 wt. % to about 0.2 wt. % of the antimicrobial composition.

4. The antimicrobial composition of claim 1, wherein the sugar alcohols constitute from about 0.5 wt. % to about 15 wt. % of the antimicrobial composition.

5. The antimicrobial composition of claim 1, wherein the weight ratio of the sugar alcohols to the antimicrobial agents is from about 2:1 to about 1000:1.

6. The antimicrobial composition of claim 1, wherein the sugar alcohols include a pentose alcohol selected from the group consisting of D-xylitol, D-arabitol, meso-ribitol (adonitol), and isomers thereof.

7. The antimicrobial composition of claim 6, wherein the pentose alcohol is D-xylitol or an isomer thereof.

8. The antimicrobial composition of claim 1, wherein the sugar alcohols include a hexose alcohol selected from the group consisting of glycerol, meso-galacitol (dulcitol), inositol, D-mannitol, D-sorbitol, and isomers thereof.

9. The antimicrobial composition of claim 1, wherein the antimicrobial agents are biocides selected from the group consisting of phenolic compounds, biguanide compounds, and quaternary ammonium compounds.

10. The antimicrobial composition of claim 9, wherein the biocides are selected from the group consisting of cetyl pyridinium chloride, triclosan, p-chlorometaxylenol, polyhexamethylene biguanide, and chlorhexidine gluconate.

11. The antimicrobial composition of claim 1, wherein the biocides are selected from the group consisting of alkoxylated amines and alkyl glycosides.

12. The antimicrobial composition of claim 1, further comprising one or more carriers in an amount from about 75 wt. % to about 99 wt. % of the composition.

13. The antimicrobial composition of claim 1, further comprising one or more gelling agents, surfactants, preservatives, pH modifiers, or combinations thereof.

14. A gel comprising the antimicrobial composition of claim 1.

15. A substrate comprising the antimicrobial composition of claim 1.

16. The substrate of claim 15, wherein the substrate includes a nonwoven web.

17. The substrate of claim 15, wherein the substrate is a laminate containing a meltblown nonwoven layer positioned between spunbond nonwoven layers.

18. The substrate of claim 15, wherein the solids add-on level of the antimicrobial composition is from about 0.001 % to about 20%.

19. A method for inhibiting the growth of a microorganism on a surface, the method comprising topically applying an antimicrobial composition to the surface, the composition comprising one or more biocides in an amount of from about 0.001 wt. % to about 0.5 wt. % and one or more sugar alcohols in an amount from about 0.1 wt. % to about 20 wt. %, wherein the antimicrobial composition achieves a log reduction of the microorganism of at least about 3 after exposure thereto for 15 minutes.

20. The method of claim 19, wherein the biocides constitute from about 0.02 wt. % to about 0.2 wt. % of the antimicrobial composition.

21. The method of claim 19, wherein the sugar alcohols constitute from about 0.5 wt. % to about 15 wt. % of the antimicrobial composition.

22. The method of claim 19, wherein the weight ratio of the sugar alcohols to the biocides is from about 2:1 to about 1000:1.

23. The method of claim 19, wherein the sugar alcohols include a pentose alcohol selected from the group consisting of D-xylitol, D-arabitol, meso-ribitol (adonitol), and isomers thereof.

24. The method of claim 23, wherein the pentose alcohol is D-xylitol or an isomer thereof.

25. The method of claim 19, wherein the biocides are selected from the group consisting of phenolic compounds, biguanide compounds, and quaternary ammonium compounds.

26. The method of claim 19, wherein the antimicrobial composition is contained on a substrate.

27. The method of claim 19, wherein the surface is a hard surface.

28. The method of claim 19, wherein the surface is skin, mucosal membrane, wound site, or surgical site.

29. The method of claim 19, wherein the antimicrobial composition achieves a log reduction of at least about 4 after exposure to the microorganism for 15 minutes.

30. The method of claim 19, wherein the microorganism is a bacteria.

31. The method of claim 30, wherein the bacteria is P. aeruginosa or S. aureus.
